(19) United States
(12) Patent Application Publication
(10) Pub. No.: US 2026/0318936 A1
(43) Pub. Date: Oct. 15, 2026

(54) FULLY AUTOMATIC ASSEMBLY-LINE BIOCHEMICAL TESTING PLATFORMS AND CONTROL METHODS THEREOF

(71) Applicant: TAIYUAN UNIVERSITY OF TECHNOLOGY, Jinzhong (CN)

(72) Inventors: Shengbo SANG, Jinzhong (CN); Haitao ZHANG, Jinzhong (CN); Dong ZHAO, Jinzhong (CN); Xingbo YU, Jinzhong (CN); Xing GUO, Jinzhong (CN)

(73) Assignee: TAIYUAN UNIVERSITY OF TECHNOLOGY, Jinzhong (CN)

(21) Appl. No.: 19/267,627

(22) Filed: Jul. 13, 2025

(30) Foreign Application Priority Data
Apr. 11, 2025 (CN) 202510455087.X

(51) Int. Cl. G01N 35/00; G01N 35/04; G01N 35/10

(52) U.S. Cl. CPC G01N 35/0099; G01N 35/00693; G01N 35/1002; G01N 35/1011; G01N 2035/046

(57) ABSTRACT

A fully automatic assembly-line biochemical testing platform and a control method are provided. The method includes: in response to detecting a start command, controlling a three-axis motion module to drive a robotic arm module to move to perform an operation of transferring a biochemical sensing array placed in a silo module to a detection module, and the detection module performing calibration on the biochemical sensing array; controlling the three-axis motion module to drive the robotic arm module to move to perform an operation of placing a calibrated biochemical sensing array on a test sample loading module; controlling the three-axis motion module to drive a pipetting module to move to perform a sample loading operation of aspirating a liquid to be tested placed in a reagent supply module and dropping the liquid to be tested onto the calibrated biochemical sensing array; and controlling the three-axis motion module to drive the robotic arm module to move after a preset time period to perform an operation of transferring a sample-loaded biochemical sensing array to the detection module, and the detection module performing detection on the sample-loaded biochemical sensing array.

### CROSS-REFERENCE TO RELATED APPLICATIONS

The application claims priority to Chinese Patent Application No. 202510455087.X, filed on Apr. 11, 2025, the entire contents of which are incorporated herein by reference.

### TECHNICAL FIELD

The disclosure relates to the technical field of biochemical sensor, and in particular, to a fully automatic assembly-line biochemical testing platform and a control method.

### BACKGROUND

Biochemical sensors have a wide range of applications in clinical medicine and environmental monitoring through the specific binding of biorecognition elements (e.g., enzymes, antibodies, DNA, etc.) to the targets and the conversion of the biological response into a measurable signal with transducers (e.g., optical, electrochemical, piezoelectric, etc.).

Currently, testing manners of the biochemical sensors rely on manual operation in the sampling and loading of samples, which is not only prone to cause errors (e.g., it is difficult to ensure the precision of sample loading), resulting in inaccurate testing results, but also has low testing efficiency, which makes it difficult to satisfy the needs of batch testing.

Therefore, it is necessary to provide a fully automatic assembly-line biochemical testing platform and a control method, which is capable of realizing automatic batch testing and improving the testing efficiency and effectiveness.

### SUMMARY

One or more embodiments of the present disclosure provide a fully automatic assembly-line biochemical testing platform. The testing platform includes: a three-axis motion module, a robotic arm module, a pipetting module, a silo module, a reagent supply module, a test sample loading module, a detection module, and a control module; wherein the three-axis motion module, the robotic arm module, the pipetting module, and the detection module are electrically connected to the control module; and the robotic arm module and the pipetting module are fixed to the three-axis motion module; wherein the control module is configured to: in response to detecting a start command, control the three-axis motion module to drive the robotic arm module to move to perform an operation of transferring a biochemical sensing array placed in the silo module to the detection module, wherein the detection module performs calibration on the biochemical sensing array; control the three-axis motion module to drive the robotic arm module to move to perform an operation of placing a calibrated biochemical sensing array on the test sample loading module; control the three-axis motion module to drive the pipetting module to move to perform a sample loading operation of aspirating a liquid to be tested placed in the reagent supply module and dropping the liquid to be tested onto the calibrated biochemical sensing array; and control the three-axis motion module to drive the robotic arm module to move after a preset time period to perform an operation of transferring a sample-loaded biochemical sensing array to the detection module, wherein the detection module performs detection on the sample-loaded biochemical sensing array.

One or more embodiments of the present disclosure also provide a control method for the fully automatic assembly-line biochemical testing platform, wherein the fully automatic assembly-line biochemical testing platform includes the three-axis motion module, the robotic arm module, the pipetting module, the silo module, the reagent supply module, the test sample loading module, the detection module, and the control module; wherein the three-axis motion module, the robotic arm module, the pipetting module, and the detection module are electrically connected to the control module; and the robotic arm module and the pipetting module are fixed to the three-axis motion module; the control method comprising: in response to detecting a start command, controlling the three-axis motion module to drive the robotic arm module to move to perform an operation of transferring the biochemical sensing array placed in the silo module to the detection module, and the detection module performing a calibration on the biochemical sensing array; controlling the three-axis motion module to drive the robotic arm module to move to perform an operation of placing a calibrated biochemical sensing array on the test sample loading module; controlling the three-axis motion module to drive the pipetting module to move to perform the sample loading operation of aspirating the liquid to be tested placed in the reagent supply module and dropping the liquid to be tested onto the calibrated biochemical sensing array; and controlling the three-axis motion module to drive the robotic arm module to move after the preset time period to perform an operation of transferring a sample-loaded biochemical sensing array to the detection module, and the detection module performing detection on the sample-loaded biochemical sensing array.

### BRIEF DESCRIPTION OF THE DRAWINGS

The disclosure will be further illustrated by way of exemplary embodiments, which will be described in detail by means of the accompanying drawings. The embodiments are not limiting, and in the embodiments, the same numbering denotes the same structure, wherein:

FIG. 1 is a schematic diagram illustrating a three-dimensional structure of a fully automatic assembly-line biochemical testing platform according to some embodiments of the present disclosure;

FIG. 2 is a schematic diagram illustrating a top view structure of a fully automatic assembly-line biochemical testing platform according to some embodiments of the present disclosure;

FIG. 3 is a schematic diagram illustrating a structure of a three-axis motion module according to some embodiments of the present disclosure;

FIG. 4 is a schematic diagram illustrating a structure of a tray according to some embodiments of the present disclosure;

FIG. 5 is a schematic diagram illustrating a structure of a pipetting module according to some embodiments of the present disclosure;

FIG. 6 is a schematic diagram illustrating a structure of a detection module according to some embodiments of the present disclosure;

FIG. 7 is a schematic diagram illustrating a structure of a test sample loading module according to some embodiments of the present disclosure;

FIG. 8 is another schematic diagram illustrating a structure of a test sample loading module according to some embodiments of the present disclosure;

FIG. 9 a flowchart illustrating an exemplary process of a control method for a fully automatic assembly-line biochemical testing platform according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with the accompanying drawings without creative labor. Unless obviously obtained from the context or the context illustrates otherwise, the same numeral in the drawings refers to the same structure or operation.

Some embodiments of the present disclosure provide a fully automatic assembly-line biochemical testing platform (hereinafter referred to as a testing platform).

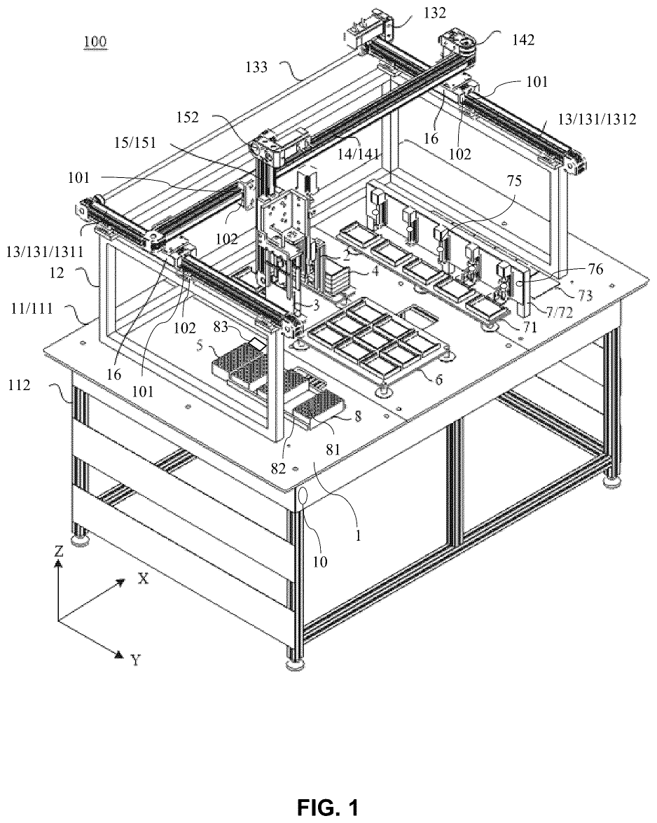

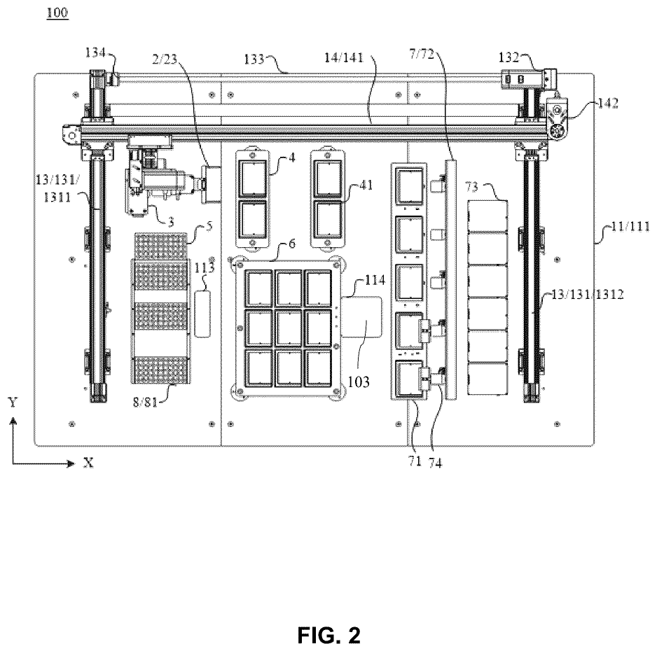

FIG. 1 is a schematic diagram illustrating a three-dimensional structure of a fully automatic assembly-line biochemical testing platform according to some embodiments of the present disclosure; FIG. 2 is a schematic diagram illustrating a top view structure of a fully automatic assembly-line biochemical testing platform according to some embodiments of the present disclosure.

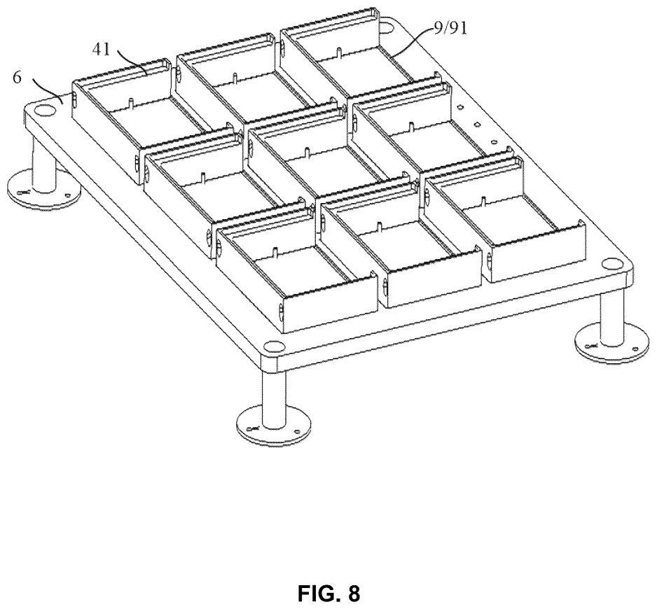

In some embodiments, as shown in FIGS. 1 and 2, the fully automatic assembly-line biochemical testing platform 100 (hereinafter referred to as the testing platform 100) includes: a three-axis motion module 1, a robotic arm module 2, a pipetting module 3, a silo module 4, a reagent supply module 5, a test sample loading module 6, a detection module 7, and a control module 10. The three-axis motion module 1, the robotic arm module 2, the pipetting module 3, and the detection module 7 are electrically connected to the control module 10; and the robotic arm module 2 and the pipetting module 3 are fixed to the three-axis motion module 1. The control module 10 is configured to: in response to detecting a start command, control the three-axis motion module 1 to drive the robotic arm module 2 to move to perform an operation of transferring a biochemical sensing array 9 placed in the silo module 4 (see FIG. 8) to the detection module 7, the detection module 7 performing calibration on the biochemical sensing array 9; control the three-axis motion module 1 to drive the robotic arm module 2 to move to perform an operation of placing a calibrated biochemical sensing array 9 on the test sample loading module 6; control the three-axis motion module 1 to drive the pipetting module 3 to move to perform a sample loading operation of aspirating a liquid to be tested placed in the reagent supply module 5 and dropping the liquid to be tested onto the calibrated biochemical sensing array 9; and control the three-axis motion module 1 to drive the robotic arm module 2 to move after a preset time period to perform an operation of transferring a sample-loaded biochemical sensing array 9 to the detection module 7, the detection module 7 performing detection on the sample-loaded biochemical sensing array 9.

The biochemical sensing array 9 refers to a unit integrating a plurality of biochemical sensors. In some embodiments, the biochemical sensing array 9 includes a flexible biochemical sensor. The biochemical sensing array 9 includes a plurality of biochemical sensors arrayed in a row and a signal interface 91 connected to the plurality of biochemical sensors. After the biochemical sensing array 9 is transferred to the detection module 7, the detection module 7 fixes the biochemical sensing array 9 and electrically connects with the signal interface 91 of the biochemical sensing array 9 to input signals from the plurality of biochemical sensors on the biochemical sensing array 9 to the detection module 7.

The silo module 4 is configured to hold an undetected biochemical sensing array 9. In some embodiments, as shown in FIG. 1 and FIG. 2, the silo module 4 includes stacked trays 41, the trays 41 are configured to hold and fix the undetected biochemical sensing array 9. During the testing process, the undetected biochemical sensing array 9 is fixed in a tray 41, and the robotic arm module 2 transfers the undetected biochemical sensing array 9 and the tray 41 simultaneously.

The reagent supply module 5 is configured to place a reagent solution to be dropped. In some embodiments, the reagent solution to be dropped at least includes the liquid to be tested. In some embodiments, the reagent solution to be dropped further includes a buffer solution and distilled water. The liquid to be tested refers to a liquid sample to be analyzed. For example, the liquid to be tested may include a blood sample, a water quality sample, a food extract, an enzyme reagent, or the like.

The test sample loading module 6 is configured to place the calibrated biochemical sensing array 9. In some embodiments, after sample loading, the biochemical sensing array 9 continues to be placed in the test sample loading module 6 for the preset time period, allowing the liquid to be tested to specifically bind to the plurality of biochemical sensors.

In some embodiments, the control module 10 is further configured to: determine a preset time period based on a droplet volume of the liquid to be tested dropped onto the biochemical sensing array 9.

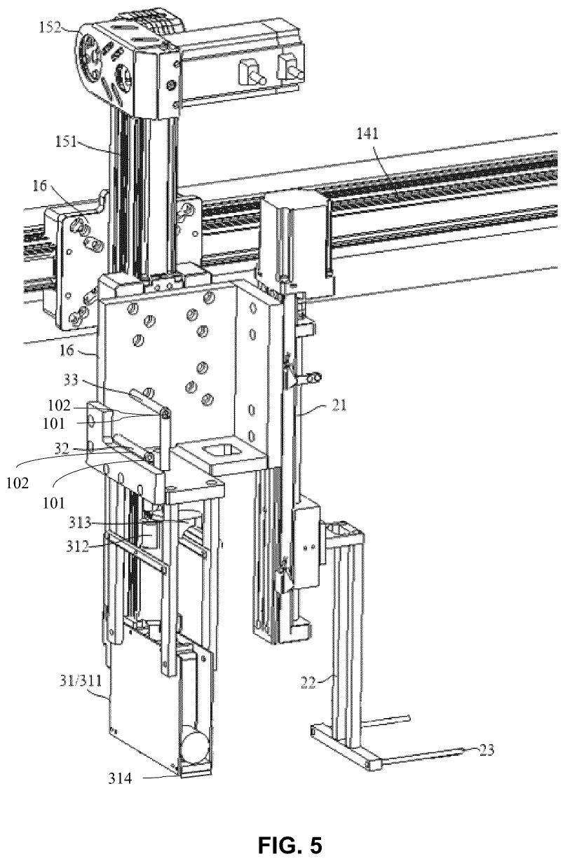

The droplet volume refers to a volume of the liquid to be tested that is dropped onto the biochemical sensing array 9. In some embodiments, the control module 10 may be configured to obtain a weight of the liquid to be tested collected by a monitoring sensor (e.g., a gravity sensor) and determine the droplet volume based on the weight and a density of the liquid to be tested. More descriptions regarding the monitoring sensor may be found in FIG. 5 and related descriptions thereof. The density of the liquid to be tested may be obtained in advance by experimental analysis and uploaded to the control module 10 by a host computer. More descriptions regarding the host computer may be found in related descriptions below.

In some embodiments, the preset time period is positively correlated with the droplet volume of the liquid to be tested dropped onto the biochemical sensing array 9. For example, the larger the droplet volume is, the farther a distance (i.e., a mass transfer path) for reactants in a droplet to diffuse from a center of the droplet to contact with a biochemical sensing interface is, and therefore the longer the preset time period is. As another example, the larger the droplet volume is, the larger a difference in a concentration gradient within the droplet is, and thus the preset time period need to be set longer to make the concentration within the droplet homogeneous. For biochemical reactions such as an enzyme reaction, antibody binding, etc., a reaction area tends to be concentrated in a contact area between the droplet and a surface of a sensing array, and the larger the droplet volume is, the longer the preset time period is to ensure that the reaction is sufficient.

Merely by way of example, the control module 10 may be configured to determine the preset time period based on the following formula (1):

T=T₀+k₀V (1).

In the formula, T denotes the preset time period, T₀ denotes a basic waiting time period after a normalization process, V denotes the droplet volume after the normalization process, and k₀ denotes a volume coefficient. The basic waiting time period refers to a baseline value for placing the biochemical sensing array 9 within the test sample loading module 6, and the basic waiting time period and the volume coefficient may be set based on experience. The normalization process includes one of a Max-Min normalization, a Z-score normalization, or the like.

In some embodiments of the present disclosure, determining the time period for placing the biochemical sensing array within the test sample loading module by the droplet volume, on the one hand, can avoid the wastage of time resources caused by artificially setting the time period to be too long, and on the other hand, can also ensure that the liquid to be tested fully binds to the plurality of biochemical sensors.

The detection module 7 is configured to perform calibration on the undetected biochemical sensing array 9 and perform detection on the sample-loaded biochemical sensing array 9, ultimately obtaining a target detection metric. The target detection metric at least includes a resistance change value.

The pipetting module 3 refers to a device, an apparatus, or a component having a pipetting function. For example, the pipetting module 3 may include at least one of a micro-pipette, a microsyringe, a microfluidic device, etc.

In some embodiments, the pipetting module 3 includes a multi-channel pipette. The multi-channel pipette may simultaneously aspirate a plurality of liquid to be tested and perform sample loading on the plurality of biochemical sensors on the biochemical sensing array 9, which is conducive to improving the efficiency of the detection.

The three-axis motion module 1 refers to a platform that achieves precise motion in a first direction, a second direction, and a third direction, and the first direction, the second direction, and the third direction are perpendicular to each other. In some embodiments, both the robotic arm module 2 and the pipetting module 3 are fixed to the three-axis motion module 1 and move under the drive of the three-axis motion module 1.

The robotic arm module 2 is configured to move the biochemical sensing array 9. In some embodiments, the robotic arm module 2 may move in a three-dimensional space among the silo module 4, the detection module 7, and the test sample loading module 6 under the drive of the three-axis motion module 1, to complete an operation of transferring the biochemical sensing array 9 from the silo module 4 to the detection module 7, and an operation of transferring the biochemical sensing array 9 from the detection module 7 to the test sample loading module 6 with a fetching function of the robotic arm module 2.

In some embodiments, the pipetting module 3 may move in a three-dimensional space between the reagent supply module 5 and the test sample loading module 6 under the drive of the three-axis motion module 1, to complete the sample loading operation of aspirating liquid in the reagent supply module 5 and dropping liquid onto the test sample loading module 6 with functions of aspirating liquid and dropping liquid of the pipetting module 3.

The control module 10 refers to a controller of the testing platform 100 and communicates with the three-axis motion module 1, the robotic arm module 2, the pipetting module 3, and the detection module 7 by corresponding communication protocols (e.g., Modbus, Wi-Fi, Bluetooth, etc.). The control module 10 controls working logic and parameter configuration of the three-axis motion module 1, the robotic arm module 2, the pipetting module 3, and the detection module 7, and performs a fully automated testing operation of the biochemical sensing array 9 in accordance with a preset logic. In some embodiments, the control module 10 includes one of a micro-controller unit (MCU), a field programmable gate array (FPGA), a digital signal processing (DSP), etc., and a control program is stored in the control module 10.

In some embodiments, at least one of the three-axis motion module 1, the robotic arm module 2, and the pipetting module 3 further includes a vibration reducing component 101. The testing platform 100 further includes a vibration sensor 102 configured to monitor a vibration displacement. The control module 10 is further configured to: in response to determining that the vibration displacement of the at least one of the three-axis motion module 1, the robotic arm module 2, and the pipetting module 3 satisfies a preset condition, control a motion of the at least one of the three-axis motion module 1, the robotic arm module 2, and the pipetting module 3.

The vibration reducing component 101 refers to a component configured to reduce or absorb vibrations or shocks generated during motion. For example, the vibration reducing component may include a rubber mat, a soft fabric, etc.

In some embodiments, the vibration reducing component 101 may be mounted on a slide rail of the at least one of the three-axis motion module 1, the robotic arm module 2, and the pipetting module 3.

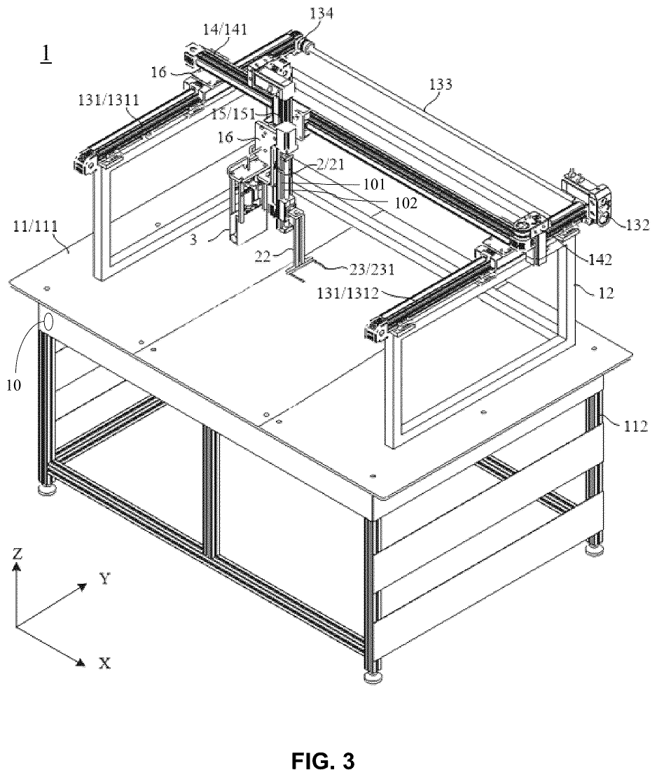

For example, as shown in FIG. 1, the vibration reducing component 101 may be mounted on a sliding connection of at least one of a first motion mechanism 13, a second motion mechanism 14, and a third motion mechanism 15 with a connecting assembly 16. More descriptions regarding the first motion mechanism 13, the second motion mechanism 14, the third motion mechanism 15, and the connecting assembly 16 may be found in FIG. 3 and related descriptions thereof.

As another example, the vibration reducing component 101 may be mounted on a first rail portion 21. More descriptions regarding the first rail portion 21 may be found in FIG. 3 and related descriptions thereof.

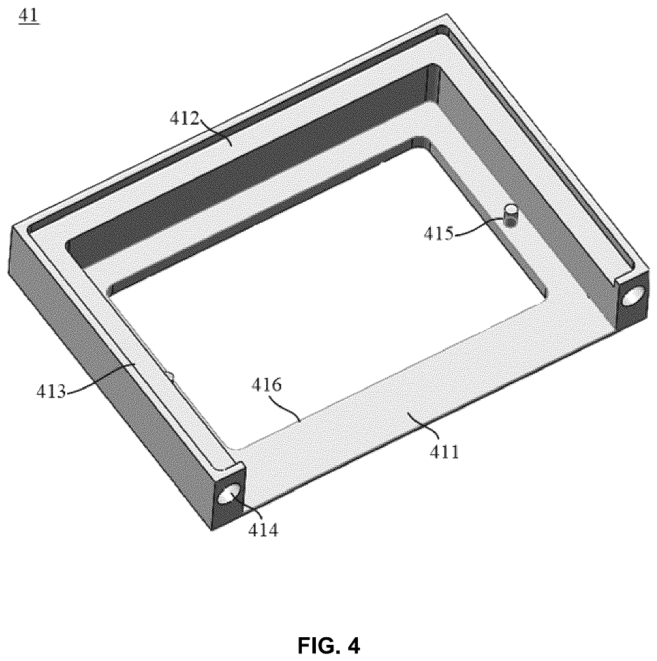

As another example, the vibration reducing component 101 may be mounted between a pipette 31 and a top contact surface of the first cylinder 32 and/or between the pipette 31 and a top contact surface of the second cylinder 33. More descriptions regarding the pipette 31, the first cylinder 32, and the second cylinder 33 may be found in FIG. 4 and related descriptions thereof.

The vibration displacement refers to a deviation displacement generated in an unintended motion direction due to a mechanical vibration or an inertial impact during operation of a structure.

In some embodiments, a setting position of the vibration sensor 102 is similar to the setting position of the vibration reducing component 101, and the setting position of the vibration sensor 102 is a preset distance away from the setting position of the vibration reducing component 101 to capture the vibration displacement. The preset distance may be set based on experience. The vibration sensor 102 includes at least one of a displacement sensor, a three-axis acceleration sensor, etc. The vibration sensor 102 may be communicatively connected to the control module 10.

The preset condition may be set by a person skilled in the art based on experience and stored in the control module 10. For example, the preset condition may include: in response to determining that a vibration displacement of the three-axis motion module 1 is greater than a first displacement threshold, controlling a motor of the three-axis motion module 1 to reduce a rotational speed; in response to determining that a vibration displacement of the robotic arm module 2 is greater than a second displacement threshold, controlling a motor of the robotic arm module 2 to reduce a rotational speed; and in response to determining that a vibration displacement of the pipetting module 3 is greater than a third displacement threshold, controlling a motor of the pipetting module 3 to reduce a rotational speed.

It is worth stating that the first displacement threshold, the second displacement threshold, and the third displacement threshold may be the same or different and may be set separately by a person skilled in the art based on experience. The control module 10 may linearly reduce a rotational speed of a motor of a corresponding module based on a magnitude by which the vibration displacement exceeds a displacement threshold of the corresponding module. A correspondence between the magnitude by which the vibration displacement exceeds the displacement threshold and a magnitude of the linear reduction may be preset based on experience.

In some embodiments of the present disclosure, it is possible to reduce the vibration displacement generated by the motion of the module by providing the vibration reducing component, which can make the form of the gripped biochemical sensing array stable, so as to ensure that the volume of the liquid to be tested is stable.

Merely by way of example, a testing process of the testing platform 100 is as follows:
(1) The robotic arm module 2 moves to the silo module 4 under the drive of the three-axis motion module 1 to grip the biochemical sensing array 9 placed in the silo module 4.
(2) The robotic arm module 2 moves to the detection module 7 under the drive of the three-axis motion module 1 to place the biochemical sensing array 9 at a detection position of the detection module 7.
(3) When the detection module 7 detects that the biochemical sensing array 9 is placed at the detection position, the detection module 7 calibrates the biochemical sensing array 9.
(4) The robotic arm module 2 grips the calibrated biochemical sensing array 9 and moves to the test sample loading module 6 under the drive of the three-axis motion module 1, to place the calibrated biochemical sensing array 9 on the test sample loading module 6.
(5) The pipetting module 3 moves to the reagent supply module 5 under the drive of the three-axis motion module 1 to aspirate the liquid to be tested.
(6) The pipetting module 3 moves to the test sample loading module 6 under the drive of the three-axis motion module, to complete the sample loading operation of dropping the liquid to be tested onto the biochemical sensing array 9.
(7) Waiting for the preset time period, the robotic arm module 2 grips the sample-loaded biochemical sensing array 9, moves to the detection module 7 under the drive of the three-axis motion module 1, and places the sample-loaded biochemical sensing array 9 at the detection position of the detection module 7 again.
(8) The detection module 7 detects the sample-loaded biochemical sensing array to obtain the target detection metric.

In some embodiments of the present disclosure, the testing platform can realize a fully automatic operation and an assembly-line testing of the biochemical sensing array, which can eliminate the need for manual operation and reduce the error caused by manual intervention, so as to improve the testing efficiency and the testing quality and satisfy the needs of batch testing.

It should be noted that the testing platform 100 provided in the present disclosure also contains test strips and reagent kits applied to the biochemical sensing array 9, shapes and sizes of the test strips and the reagent kits match to the trays 41, and the silo module 4, the test sample loading module 6, and the detection module 7 match to the trays 41.

FIG. 3 is a schematic diagram illustrating a structure of a three-axis motion module according to some embodiments of the present disclosure.

In some embodiments, as shown in FIG. 3, the three-axis motion module 1 includes a base 11, a support structure 12, the first motion mechanism 13, the second motion mechanism 14, the third motion mechanism 15, and the connecting assembly 16. The support structure 12 is located on the base 11; the first motion mechanism 13 is located on a side of the support structure 12 away from the base 11, the first motion mechanism 13 extending in a first direction Y; the second motion mechanism 14 is slidably connected to the first motion mechanism 13 by the connecting assembly 16, the second motion mechanism 14 moving in the first direction Y and extending in a second direction X; the third motion mechanism 15 is slidably connected to the second motion mechanism 14 by the connecting assembly 16, the third motion mechanism 15 moving in the second direction X and extending in a third direction Z; and the robotic arm module 2 and the pipetting module 3 are slidably connected to the third motion mechanism 15 by the connecting assembly 16, the robotic arm module 2 and the pipetting module 3 moving in the third direction Z. The first direction Y, the second direction X, and the third direction Z are perpendicular to each other.

In some embodiments, the base 11 is a platform base. Merely by way of example, as shown in FIG. 3, the base 11 includes a surface 111 and a column 112, the surface 111 is located on a side of the column 112, and the support structure 12 is located on a side of the surface 111 away from the column 112. In some embodiments, as shown in FIG. 3, the base 11 further includes a leveling mechanism, the leveling mechanism is located on a side of the column 112 away from the surface 111, and the leveling mechanism is configured to level the surface 111.

In some embodiments, the support structure 12 is located on the base 11, and the support structure 12 is fixedly connected to the base 11. A fixed connection includes at least one of a bolting/screwing connection, a welding connection, a riveting connection, a plugging connection, a bonding connection, or the like. The support structure 12 of the present disclosure may be flexibly set up based on needs. Merely by way of example, as shown in FIG. 1 and FIG. 3, the support structure 12 includes an aluminum rectangular frame set on three sides, which has good structural stability.

In some embodiments, the first motion mechanism 13 is located on the side of the support structure 12 away from the base 11, the first motion mechanism 13 is fixedly connected to the support structure 12, and the first motion mechanism 13 extends in the first direction Y. The second motion mechanism 14 is slidingly connected to the first motion mechanism 13 by the connecting assembly 16, and when the first motion mechanism 13 moves in the first direction Y, the first motion mechanism 13 drives the second motion mechanism 14 to move linearly in an extension direction (i.e., the first direction Y) of the first motion mechanism 13, and the second motion mechanism 14 also extends in the second direction X. The third motion mechanism 15 is slidingly connected to the second motion mechanism 14 by the connecting assembly 16, and when the second motion mechanism 14 moves in the second direction X, the second motion mechanism 14 drives the third motion mechanism 15 to move linearly in an extension direction (i.e., the second direction X) of the second motion mechanism 14, and the third motion mechanism 15 also extends in the third direction Z. The robotic arm module 2 and the pipetting module 3 are slidably connected to the third motion mechanism 15 by the connecting assembly 16, and when the third motion mechanism 15 moves in the third direction Z, the third motion mechanism 15 drives the robotic arm module 2 and the pipetting module 3 to move in the third direction Z.

In some embodiments, as shown in FIG. 1 or FIG. 3, the connecting assembly 16 includes an open-hole platform, the open-hole platform includes a first open-hole platform, a second open-hole platform, and a third open-hole platform, the first open-hole platform is slidingly connected to the first motion mechanism 13, the second motion mechanism 14 is fixedly connected to the first open-hole platform; the second open-hole platform is slidably connected to the second motion mechanism 14, the third motion mechanism 15 is fixedly connected to the second open-hole platform; and the third open-hole platform is slidably connected to the third motion mechanism 15, and the robotic arm module 2 and the pipetting module 3 are fixedly connected to the third open-hole platform.

In some embodiments of the present disclosure, the robotic arm module 2 and the pipetting module 3 can be driven to move in the three-dimensional space where the three-axis motion module 1 is located in the first direction Y, the second direction X, and the third direction Z by controlling the motion of the first motion mechanism 13, the second motion mechanism 14, and the third motion mechanism 15. The silo module 4, the reagent supply module 5, the test sample loading module 6, and the detection module 7 are all located in the three-dimensional space where the three-axis motion module 1 is located by fixing the silo module 4, the reagent supply module 5, the test sample loading module 6, and the detection module 7 on the top surface of the base 11, under the drive of the three-axis motion module 1, the robotic arm module 2 moves in the three-dimensional space among the silo module 4, the detection module 7, and the test sample loading module 6, and the pipetting module 3 moves in the three-dimensional space between the reagent supply module 5 and the test sample loading module 6.

In some embodiments, as shown in FIG. 1 or FIG. 3, the first motion mechanism 13 includes a first synchronous belt 131 and a first motor 132, and the first motor 132 drives the first synchronous belt 131 to move in the first direction Y; the second motion mechanism 14 includes a second synchronous belt 141 and a second motor 142, and the second motor 142 drives the second synchronous belt 141 to move in the second direction X; and the third motion mechanism 15 includes a third synchronous belt 151 and a third motor 152, and the third motor 152 drives the third synchronous belt 151 to move in the third direction Z.

In some embodiments, the first motor 132 is configured to drive the first motion mechanism 13 to move in the first direction Y, the second motor 142 is configured to drive the second motion mechanism 14 to move in the second direction X, and the third motor 152 is configured to drive the third motion mechanism 15 to move in the third direction Z. The first motor 132, the second motor 142, and the third motor 152 may include at least one of a servo motor, a stepper motor, or the like.

In some embodiments, the control module 10 is configured to: determine an expiration time of the liquid to be tested based on a type of the liquid to be tested and the environmental data; determine moving speeds of the first synchronous belt 131, the second synchronous belt 141, and the third synchronous belt 151 based on the expiration time of the liquid to be tested, and control the first motor 132 to drive the first synchronous belt 131 to move, the second motor 142 to drive the second synchronous belt 141 to move, and the third motor 152 to drive the third synchronous belt 151 to move.

In some embodiments, the type of the liquid to be tested may include at least one of a blood sample, a water quality sample, a food extract, an enzyme reagent, or the like. A technician may upload the type of the liquid to be tested to the control module 10 by a host computer. More descriptions regarding the host computer may be found in related descriptions below.

The environmental data refers to data related to the environment in which the liquid to be tested is located. For example, the environmental data includes a temperature, a humidity, an atmospheric pressure, or the like. In some embodiments, the environmental data may be obtained by sensors (e.g., a temperature sensor, a humidity sensor, an atmospheric pressure sensor, etc.) installed in the environment, and the sensors are communicatively connected to the control module 10.

The expiration time of the liquid to be tested refers to a maximum allowable time for a change in a physicochemical property or a biological activity of the liquid to be tested to result in a distortion of a testing result. It is understood that the expiration time of the liquid to be tested is related to the type of the liquid to be tested and an environment in which the liquid to be tested is located, and the liquid to be tested may expire or may not expire.

In some embodiments, the control module 10 may determine the expiration time of the liquid to be tested by querying a first preset table based on the type of the liquid to be tested and the environmental data.

The first preset table contains expiration time of a plurality of different types of liquids to be tested under different environmental data. The first preset table may be constructed based on historical data by the following manner: collecting the plurality of different types of liquids to be tested; measuring environmental data of an environment in which the liquid to be tested is located; measuring a maximum time for the liquid to be tested maintaining stable reaction performance, and using the maximum time as the expiration time of the liquid to be tested; and constructing the first preset table based on the plurality of different types of liquids to be tested, the environmental data, and the corresponding expiration time.

In some embodiments, the moving speeds of the first synchronous belt 131, the second synchronous belt 141, and the third synchronous belt 151 are negatively correlated with the expiration time of the liquid to be tested.

Merely by way of example, the control module 10 may determine the moving speeds of the first synchronous belt 131, the second synchronous belt 141, and the third synchronous belt 151 based on the following formula (2):

vᵢ=vⁱ₀−kⁱ_{T}Tₗ (2.

In the formula, vᵢ denotes a moving speed of an ith synchronous belt, vⁱ₀ denotes an initial speed of the ith synchronous belt after a normalization process, kⁱ_{T} denotes a speed coefficient of the ith synchronous belt after the normalization process, Tₗ denotes the expiration time of the liquid to be tested after the normalization process, i denotes an index of the synchronous belt and/or a motion mechanism, and i=1, 2, 3. An initial speed of the first synchronous belt 131, an initial speed of the second synchronous belt 141, and an initial speed of the third synchronous belt 151 may be the same or different, and a speed coefficient of the first synchronous belt 131, a speed coefficient of the second synchronous belt 141, and a speed coefficient of the third synchronous belt 151 may be the same or different, which may be set by a person skilled in the art based on experience. The normalization process includes one of a Max-Min normalization, a Z-score normalization, or the like.

In some embodiments, the control module 10 may determine the rotational speeds of the first motor 132, the second motor 142, and the third motor 152 based on the moving speeds of the first synchronous belt 131, the second synchronous belt 141, and the third synchronous belt 151, so as to drive the first synchronous belt 131, the second synchronous belt 141, and the third synchronous belt 151 to move.

In some embodiments of the present disclosure, it is possible to avoid premature oxidation of the reagent by determining the moving speed based on the expiration time of the liquid to be tested, which can improve the testing accuracy.

In some embodiments, the control module 10 is further configured to: randomly generate a plurality of candidate speed combinations, predict an abnormal risk value corresponding to each of the plurality of candidate speed combinations by a risk prediction model; determine a target speed combination based on a plurality of abnormal risk values; and the risk prediction model is a machine learning model.

A speed combination refers to a combination of the moving speeds of the first synchronous belt 131, the second synchronous belt 141, and the third synchronous belt 151. A candidate speed combination refers to a combination of the moving speeds that are candidates for use by the first synchronous belt 131, the second synchronous belt 141, and the third synchronous belt 151.

In some embodiments, the control module 10 may randomly generate, based on a speed deviation value Δvᵢ of the ith synchronous belt, the plurality of candidate speed combinations between vᵢ−Δvᵢ and vᵢ+Δvᵢ on the basis of the moving speeds of the first synchronous belt 131, the second synchronous belt 141, and the third synchronous belt 151 (i.e., the moving speeds determined based on the formula (2) above). A speed deviation value of the first synchronous belt 131, a speed deviation value of the second synchronous belt 141, and a speed deviation value of the third synchronous belt 151 may be the same or different and may be set by those skilled in the art based on experience.

The abnormal risk value refers to a probability of an abnormal event (e.g., excessive vibration displacement, sample loading failure, or cleaning contamination) occurring in the monitoring platform when the first synchronous belt 131, the second synchronous belt 141, and the third synchronous belt 151 are operating at a certain speed combination.

In some embodiments, the control module 10 may input the plurality of candidate speed combinations and the environmental data to the risk prediction model, and the risk prediction model outputs the abnormal risk values corresponding to the plurality of candidate speed combinations.

In some embodiments, the risk prediction model may be a Neural Network (NN) model, etc., or a combination of one or more of other customized models.

In some embodiments, the risk prediction model may be obtained by training based on a plurality of first training samples with first labels. For example, the plurality of first training samples with the first labels may be input to an initial risk prediction model, a loss function is constructed from the first labels and results output by the initial risk prediction model, and parameters of the initial risk prediction model are iteratively updated based on the loss function by gradient descent or other methods. The model training is completed until a preset condition is satisfied, and a trained risk prediction model is obtained. The preset condition may be that the loss function converges, a count of iterations reaches a threshold, etc.

A first training sample includes a sample speed combination and a sample environmental data from historical data, and a first label is a sample abnormal risk value corresponding to the first training sample. A technician or a statistical device may divide a plurality of data in the historical data with the same sample speed combination and the same sample environmental data into a parameter combination, determine a count of data in the parameter combination in which an abnormal event occurring, and use a ratio of the count of data in which the abnormal event occurring to a total count of data in the parameter combination as the first label corresponding to the sample speed combination and the sample environmental data.

In some embodiments, the control module 10 may use a candidate speed combination with a smallest abnormal risk value among the plurality of candidate speed combinations as the target speed combination.

In some embodiments of the present disclosure, it is possible to prevent large vibrations due to excessively fast speed changes of the synchronous belt in the three axial directions by randomly generating a plurality of candidate speed combinations and determining the target speed combination based on the plurality of abnormal risk values, so as to reduce interference with testing accuracy.

In some embodiments, as shown in FIG. 1 or FIG. 3, the first synchronous belt 131 includes a first sub-synchronous belt 1311 and a second sub-synchronous belt 1312, and the first sub-synchronous belt 1311 and the second sub-synchronous belt 1312 are set in parallel; the first motion mechanism 13 further includes couplings 134 and a connecting rod 133, the connecting rod 133 connects the first sub-synchronous belt 1311 to the second sub-synchronous belt 1312 by the couplings 134, and the couplings 134 further connect to the first motor 132.

In some embodiments, each end of the connecting rod 133 is connected to a coupling 134, one of the couplings 134 is connected to the first sub-synchronous belt 1311 and the other coupling 134 is connected to the second sub-synchronous belt 1312, and the connection of the first sub-synchronous belt 1311 and the second sub-synchronous belt 1312 is realized by the connecting rod 133 and the couplings 134. One of the couplings 134 is also connected to the first motor 132, and when the first motor 132 works, the first motor 132 drives the couplings 134 to rotate, to drive the first sub-synchronous belt 1311 and the second sub-synchronous belt 1312 to rotate at the same time, so as to enable the first sub-synchronous belt 1311 and the second sub-synchronous belt 1312 to maintain synchronous rotation.

In some embodiments, as shown in FIG. 3, the robotic arm module 2 includes a first rail portion 21, a first sliding portion 22, and a transfer portion 23, the first rail portion 21 is slidingly connected to the third motion mechanism 15 (or the third synchronous belt 151) by the connecting assembly 16, the first rail portion 21 extends in the third direction Z, the first sliding portion 22 moves in the third direction Z, the first sliding portion 22 is fixedly connected to the transfer portion 23, and the transfer portion 23 is configured to transfer the biochemical sensing array 9.

In some embodiments, the connecting assembly 16 is slidingly connected to the third motion mechanism 15 (or the third synchronous belt 151), the first rail portion 21 is fixedly connected to the connecting assembly 16, the first rail portion 21 extends in the third direction Z, and the first sliding portion 22 may slide along the first rail portion 21, i.e., the first sliding portion 22 moves in the third direction Z to drive the transfer portion 23 that is fixedly connected to the first sliding portion 22 to move in the third direction Z.

Merely by way of example, as shown in FIG. 3, the first rail portion 21 includes a pole extending in the third direction Z, the first sliding portion 22 is slidably connected to the pole by the connecting assembly 16, the connecting assembly 16 is slidably connected to the pole, the connecting assembly 16 is fixedly connected to the first sliding portion 22, and the transfer portion 23 includes two strips disposed in parallel, sizes of the two strips match a size of the trays 41, and the two strips are configured to transfer the biochemical sensing array 9.

FIG. 4 is a schematic diagram illustrating a structure of a tray according to some embodiments of the present disclosure.

In some embodiments, as shown in FIG. 3 and FIG. 4, the transfer portion 23 includes a fork structure 231; and the silo module 4 includes stacked trays 41, the trays 41 are configured to hold the biochemical sensing array 9, the trays 41 include insertion holes 414; and the insertion holes 414 is matched to the fork structure 231.

In some embodiments, the fork structure 231 includes the two strips disposed in parallel.

In some embodiments, the fork structure 231 of the robotic arm module 2 is inserted into the insertion holes 414 of a tray 41, and the control module 10 controls the motion of the three-axis motion module 1, so as to drive the robotic arm module 2 to transfer the tray 41 and the biochemical sensing array 9 simultaneously to a target position.

In some embodiments, as shown in FIG. 4, the tray 41 includes a bottom plate 411, a back plate 412, and two side plates 413; each side plate 413 is provided with an insertion hole 414 in a direction of the back plate 412 toward each side plate 413, and the insertion hole 414 is matched to the transfer portion 23.

In some embodiments, a three-sided surrounded accommodation space is formed among the back plate 412 and the two side plates 413, the accommodation space is configured to hold the biochemical sensing array 9, and the signal interface 91 of the biochemical sensing array 9 is located on a side close to an opening of the accommodation space.

It should be noted that FIG. 4 only exemplarily illustrates that the insertion hole 414 is a through-hole penetrating the side plate 413, which does not constitute a limitation of the present disclosure. In other embodiments, the insertion hole 414 may also be a blind hole that does not penetrate the side plate 413.

In some embodiments, as shown in FIG. 4, the bottom plate 411 is provided with positioning structures 415, and the positioning structures 415 are configured to fix the biochemical sensing array 9 on the bottom plate 411, to prevent the biochemical sensing array 9 from shifting in position.

Merely by way of example, as shown in FIG. 4, a positioning structure 415 includes a positioning pole, and the biochemical sensing array 9 includes positioning holes that corresponds to positioning poles, and the positioning poles pass through the positioning holes to fix the biochemical sensing array 9 on the bottom plate 411 of the tray 41.

In some embodiments, the transfer portion 23 includes a mechanical gripper. A gripping force of the mechanical gripper is adjustable, which is set in a range of 0.1 N to 5 N.

In some embodiments, the mechanical gripper includes a parallel opening and closing type gripper. The parallel opening and closing type gripper may rotate in a horizontal plane and grip in a vertical plane. The mechanical gripper also includes a gripping surface and an anti-slip layer, and the anti-slip layer covers the gripping surface.

In some embodiments, a height of the back plate 142 is greater than heights of the side plates 413 of the tray 41 to form a gripping portion in order to facilitate gripping by the mechanical gripper.

In some embodiments, the silo module 4 further includes: a photoelectric sensor and an alarm, and the photoelectric sensor and the alarm are electrically connected to the control module 10.

The photoelectric sensor is configured to detect a remaining quantity of the biochemical sensing array in the silo module 4 and transmit a signal to the control module 10. The control module 10 is configured to determine the remaining quantity in the silo module 4 based on the signal transmitted by the photoelectric sensor; and in response to determining that the remaining quantity is less than a preset remaining quantity, control the alarm to prompt an alarm. The preset remaining quantity is set based on experience.

The present disclosure does not limit the type of the alarm, and any electronic device with a prompting function (e.g., a buzzer and/or an indicator light, etc.) may be used.

FIG. 5 is a schematic diagram illustrating a structure of a pipetting module according to some embodiments of the present disclosure.

In some embodiments, as shown in FIG. 1, FIG. 2, and FIG. 5, the pipetting module 3 includes the pipette 31, and the testing platform 100 further includes a pipette tip module 8, the pipette tip module 8 including a tip box 81 and pipette tips 82, the tip box 81 being configured to accommodate a plurality of pipette tips 82 arranged in an array; and the control module 10 is further configured to: before the pipette 31 performs an operation of aspirating a liquid to be tested, control the three-axis motion module 1 to drive the pipette 31 to move to the pipette tip module 8, to drive the pipette 31 to move towards the pipette tips 82 in the third direction Z, the pipette 31 being mounted with the pipette tips 82 utilizing pressure.

In some embodiments, the pipetting module 3 includes the pipette 31, and the pipette 31 needs to be used in conjunction with the pipette tips 82 to complete the operation of aspirating the liquid to be tested and dropping the liquid to be tested. In addition, the testing platform 100 needs to be equipped with the pipette tip module 8.

In some embodiments, the control module 10 first mounts the pipette tips 82 on the pipette 31 before performing the operation of aspirating the liquid to be tested. Merely by way of example, the process of mounting the pipette tips 82 is as follows: the pipette 31 moving above the pipette tip module 8 under the drive of the three-axis motion module 1, moving in the third direction Z (i.e., in a vertical direction) under the drive of the three-axis motion module 1, and mounting the pipette tips 82 on nozzles 314 of the pipette 31 under pressure.

Any feasible pipette (e.g., a single-channel pipette and a multi-channel pipette, etc.) may be used in embodiments of the present disclosure.

In some embodiments, the pipette tip module 8 further includes a cleaning assembly 83; and the control module 10 is configured to: in response to determining that a sample loading operation is completed, determine a cleaning parameter of the pipette tips 82 based on a type, a viscosity, and a sampling volume of the liquid to be tested aspirated by the pipette tips 82, and control the cleaning assembly 83 to clean the pipette tips 82.

The cleaning assembly 83 is configured to clean and dry the pipette tips 82. In some embodiments, the cleaning assembly 83 may include an ultrasonic cleaning tank and a drying bin. The ultrasonic cleaning tank utilizes ultrasonic waves to strip a residual liquid to be tested attached to surfaces of the pipette tips 82. The drying bin is configured to dry the pipette tips 82 after completing cleaning.

More descriptions regarding the type of the liquid to be tested may be found in FIG. 3 and related descriptions thereof.

In some embodiments, the viscosity of the liquid to be tested may be obtained by experimental analysis in advance and uploaded to the control module 10 by a host computer. More descriptions regarding the host computer may be found in related descriptions below.

The sampling volume refers to a volume of the liquid to be tested that is aspirated by the pipette 31 once. In some embodiments, the sampling volume is a parameter preset by the technician or the system.

It is understood that the greater the viscosity of the liquid to be tested is, and the greater the sampling volume is, the more liquid remained on inside walls of the pipette tips 82 is.

The cleaning parameter refers to a parameter for cleaning the pipette tips 82. For example, the cleaning parameter may include a minimum cleaning time and a drying temperature interval for the pipette tips 82.

In some embodiments, the control module 10 may query a second preset table to determine the cleaning parameter of the pipette tips 82 based on the type, the viscosity, and the sampling volume of the liquid to be tested.

The second preset table includes types, viscosities, and sampling volumes of the liquids to be tested aspirated by a plurality of pipette tips, and corresponding cleaning parameters of the pipette tips. The second preset table is constructed as follows: summarizing a plurality of historical testing records with a high precision, each historical testing record including a type, a viscosity, a sampling volume of the liquid to be tested aspirated by the pipette tips, and actual cleaning time and actual drying temperature of the pipette tips; taking historical testing records with the same type, the same viscosity, and the same sampling volume of the liquid to be tested as a data set, taking a smallest actual cleaning time in the data set as the minimum cleaning time, and determining the drying temperature interval from a smallest actual drying temperature and a largest actual drying temperature in the data set; and constructing the second preset table based on the plurality of the types, the viscosities, the sampling volumes of the liquids to be tested, and corresponding minimum cleaning time and drying temperature intervals.

In some embodiments of the present disclosure, by setting a reasonable cleaning time and drying temperature, on the one hand, it is possible to ensure that the cleaning effect of the pipette tips, and on the other hand, to avoid affecting the testing progress.

In some embodiments, the control module 10 is further configured to: determine the second preset table based on a parameter determination model; and in response to recognizing that a cleaning failure value is greater than a preset threshold, update the second preset table by the parameter determination model. The parameter determination model is periodically updated.

In some embodiments, the control module 10 may input the type, the viscosity, the sampling volume of the liquid to be tested, and the environmental data to the parameter determination model, and the parameter determination model outputs the cleaning parameter.

In some embodiments, the parameter determination model is a machine learning model. For example, the parameter determination model may be a Neural Network (NN) model, etc. or a combination of one or more of other customized models.

In some embodiments, the parameter determination model may be obtained by training through a plurality of second training samples with second labels. The training process of the parameter determination model is similar to the training process of the risk prediction model, which is not repeated here.

A second training sample may include a type, a viscosity, a sampling volume of a sample liquid to be tested, and sample environmental data, and a second label includes a sample cleaning parameter corresponding to the second training sample. The second training sample and the second label may be determined based on testing records in the historical data that satisfy a preset condition. The preset condition may include: a fluctuation in detection results of a plurality of sample biochemical sensing arrays which are in a same batch is less than a first threshold; an effect of residual liquid in the pipette tips 82 after the pipette tips 82 is cleaned on next detection results is less than a second threshold. The first threshold and the second threshold are set based on experience.

In some embodiments, the control module 10 may populate a second preset table with a plurality of types, viscosities, sampling volumes of liquids to be tested, and a plurality of cleaning parameters output by the parameter determination model in order.

The cleaning failure value refers to a count of times that the liquid to be tested is labeled as discarded subsequently due to incomplete cleaning in the last N times of a process for cleaning the pipette tips 82, sample loading, and testing subsequently. In some embodiments, the control module 10 obtains the cleaning failure value, and in response to recognizing that the cleaning failure value is greater than a preset threshold, updates the second preset table by the parameter determination model. A value of N and the preset threshold are set based on experience.

In some embodiments, the control module 10 may adjust an update period of the parameter determination model based on an initial period based on the cleaning failure value, and the update period of the parameter determination model is negatively correlated with the cleaning failure value. The initial period is set by a person skilled in the art based on experience.

In some embodiments, it is possible to avoid subsequent testing deviation due to aging of the device by updating the second preset table and the parameter determination model by the cleaning failure value.

In some embodiments, as shown in FIG. 1 and FIG. 5, the pipetting module 3 further includes the first cylinder 32, and the pipette 31 includes a pipette body 311 and a first button 312. The control module 10 is further configured to: after the pipette 31 is mounted with the pipette tips 82, control the three-axis motion module 1 to drive the pipette 31 to move to the reagent supply module 5, and control the first cylinder 32 to move in the third direction Z, the first cylinder 32 pressing the first button 312, and the pipette 31 performing an operation of aspirating the liquid to be tested to the pipette tips 82; and control the three-axis motion module 1 to drive the pipette 31 to move to the test sample loading module 6, and control the first cylinder 32 to move in the third direction Z, the first cylinder 32 pressing the first button 312 again, and the pipette 31 performing a sample loading operation of dropping the liquid to be tested in the pipette tips 82 onto the biochemical sensing array 9.

In some embodiments, the first cylinder 32 is moved telescopically in the third direction Z to press the first button 312 of the pipette 31 to generate a pressure difference between a suction tube and a discharge tube, thereby realizing aspiration and discharge of the liquid to be tested. The pipette 31 moves to the reagent supply module 5 under the drive of the three-axis motion module 1 and moves in the third direction Z to make the pipette tips 82 insert into the liquid to be tested. The control module 10 controls the first cylinder 32 to move toward the first button 312 in the third direction Z, and after the first cylinder 32 contacts with the first button 312, continues to control the first cylinder 32 to move toward the first button 312, the first cylinder 32 presses the first button to generate a negative pressure inside the pipette tips 82, the liquid to be tested is aspirated into the pipette tips 82, and the operation of aspirating the liquid to be tested is completed. Then the pipette 31 moves to the test sample loading module 6 under the drive of the three-axis motion module 1, and the pipette tips 82 are located above the biochemical sensing array 9 and corresponds one-to-one to biochemical sensors in the biochemical sensing array 9. The control module controls the first cylinder 32 to move toward the first button 312 in the third direction Z, and after the first cylinder 32 contacts with the first button 312, continues to control the first cylinder 32 to move toward the first button 312, the first cylinder 32 presses the first button 312 again, the negative pressure in the pipette tips 82 disappears, the liquid to be tested is discharged from the pipette tips 82 and dropped onto the biochemical sensing array 9, and the sample loading operation is completed.

In some embodiments, as shown in FIG. 1, FIG. 2, and FIG. 5, the pipetting module 3 further includes the second cylinder 33, the pipette 31 further includes a second button 313, and the base 11 of the three-axis motion module 1 is provided with a first opening 113. The testing platform 100 further includes a pipette tip collection module 103 and the pipette tip collection module 103 at least partially overlaps with the first opening 113 in the third direction Z. The control module 10 is further configured to control the three-axis motion module 1 to drive the pipette 31 to move above the first opening 113, and control the second cylinder 33 to move in the third direction Z, the second cylinder 33 pressing the second button 313, the pipette 31 performing an operation of unloading the pipette tips 82.

In some embodiments, the pipette 31 is also provided with the second button 313, and after performing the sample loading operation, the pipette 31 moves above a second opening 114 under the drive of the three-axis motion module 1. The control module 10 controls the second cylinder 33 to move toward the second button 313 in the third direction Z, and after the second cylinder 33 contacts with the second button 313, continues to control the second cylinder 33 to move in the direction close to the second button 313, the second cylinder 33 presses the second button 313 to unload the pipette tips 82 mounted on the pipette 31, and the pipette tips 82 fall into the pipette tip collection module 103 below the second opening 114. Such setup realizes a one-button operation of unloading the pipette tips, which simplifies the operation and is conducive to improving the testing efficiency.

It should be noted that FIG. 2 only exemplarily illustrates that the first opening 113 is disposed between the pipette tip module 8 and the test sample loading module 6, which does not constitute a limitation of the present disclosure. In other embodiments, the first opening 113 may also be disposed on the surface 111 within a movement range of the pipetting module 3.

In some embodiments, as shown in FIG. 2, the reagent supply module 5 includes a test tube rack and test tubes, the test tube rack includes a plurality of first apertures arranged in an array, the test tubes are placed inside the plurality of first apertures, and the test tubes are configured to hold the liquid to be tested.

In some embodiments, as shown in FIG. 2, the tip box 81 includes a plurality of second apertures arranged in an array, and the second apertures are configured to accommodate the pipette tips 82.

Merely by way of example, as shown in FIG. 2, the pipette tip module 8 includes three tip boxes 81 disposed side-by-side, each of the three tip boxes 81 includes the plurality of second apertures arranged in an array, and the pipette tips 82 and the plurality of second apertures are in one-to-one correspondence.

In some embodiments, distances among the plurality of first apertures are equal to distances among the plurality of second apertures.

In some embodiments, the pipette 31 includes a multi-channel pipette, the multi-channel pipette includes a plurality of nozzles 314 and a plurality of pipetting channels arranged in an array, and the plurality of nozzles 314 and the plurality of pipetting channels are in one-to-one correspondence.

For example, a distance between centerlines of two adjacent nozzles 314 is L1, and a distance between centerlines of two adjacent pipette tips 82 in the tip box 82 is L2, and the L1 is equal to the L2.

Merely by way of example, the multi-channel pipette includes a plurality of nozzles 314, and the plurality of nozzles 314 are arranged in a row.

In some embodiments, the pipette 31 further includes a plurality of nozzles 314 arranged in an array, and the plurality of nozzles 314 are connected with the pipette tips 82 in one-to-one correspondence. The control module 10 is further configured to adjust a distance between adjacent nozzles 314 and adjust volumes of the pipette tips 82 aspirating the liquid to be tested once.

In some embodiments, the pipette 31 is the multi-channel pipette, and may realize the sample loading operation of a plurality of biochemical sensors in a single operation, which is conducive to improving the testing efficiency. The distance between the adjacent nozzles 314 is adjustable, i.e., the distance between adjacent pipette tips 82 mounted on the adjacent nozzles 314 is adjustable, to make the distance between the pipette tips 82 match the distance between the test tubes.

In some embodiments, a measuring range of the pipette 31 is also adjustable, and the control module 10 adjusts the volume of the pipette tip 82 aspirating the liquid to be tested once based on needs. Merely by way of example, when 10 μL of the liquid to be tested needs to be dropped onto each biochemical sensor, the control module 10 adjusts the measuring range of the pipette 31 so that the volume of the pipette tip 82 aspirating the liquid to be tested once is 10 μL; when 15 μL of the liquid to be tested needs to be dropped onto the each biochemical sensor, the control module 10 adjusts the measuring range of the pipette 31 so that the volume of the pipette tip 82 aspirating the liquid to be tested once is 15 μL.

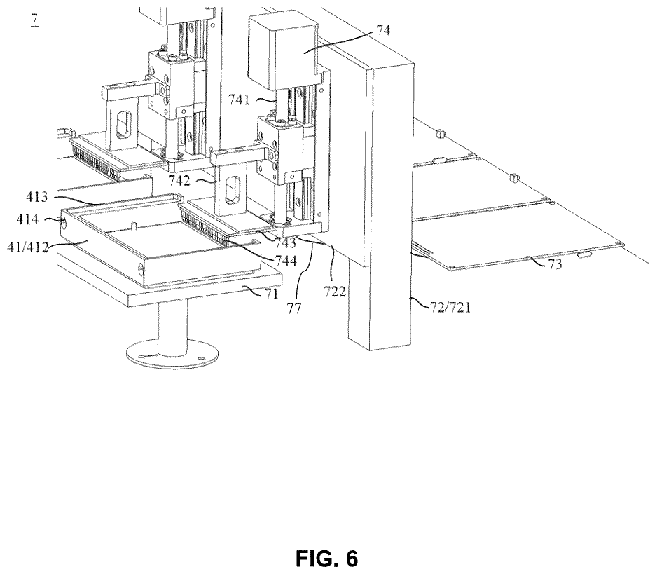

FIG. 6 is a schematic diagram illustrating a structure of a detection module according to some embodiments of the present disclosure.

In some embodiments, as shown in FIG. 6, the detection module 7 includes a fixed surface 71, an in-position sensor 75, a fixing mechanism 74, a fixing frame 72, a detection circuit board 73, and a micro-controller 76, and the fixing mechanism 74 includes a spring-loaded row pin 744, an adapter plate 743, a second rail portion 741, and a second sliding portion 742. The fixing frame 72 is configured to fix the second rail portion 741, the second sliding portion 742 slides along the second rail portion 741, the second sliding portion 742 is fixedly connected to the adapter plate 743, and the adapter plate 743 is fixedly connected to the spring-loaded row pin 744. The spring-loaded row pin 744 is further electrically connected to the adapter plate 743, the adapter plate 743 is electrically connected to the detection circuit board 73 by the flexible wiring 77, the in-position sensor 75, the second sliding portion 742, and the detection circuit board 73 are electrically connected to the micro-controller 76, and the micro-controller 76 is electrically connected to the control module 10. The micro-controller is configured to: in response to receiving an in-position signal transmitted from the in-position sensor 75, control the second sliding portion 742 to slide along the second rail portion 741, to drive the spring-loaded row pin 744 to contact with the signal interface 91 of the biochemical sensing array 9, so as to fix the biochemical sensing array 9 on the fixed surface 71, and control the detection circuit board 73 to calibrate or detect the biochemical sensing array 9. The in-position signal is generated based on a detection result of the in-position sensor 75 that the biochemical sensing array 9 is placed on the fixed surface 71.

In some embodiments, the fixed surface 71 is configured to hold the trays 41 and the biochemical sensing array 9 held in the trays 41.

In some embodiments, the detection module 7 is configured to generate the in-position signal when detecting that the biochemical sensing array 9 is placed on the fixed surface 71 and transmit the in-position signal to the micro-controller 76. Merely by way of example, the detection module 7 includes a photoelectric in-position sensor.

In some embodiments, the fixing frame 72 includes a fixing bracket 721 and a fixing plate 722, the fixing bracket 721 is fixedly connected to the base 11, the fixing plate 722 is fixedly connected to the fixing bracket 721, and the fixing mechanism 74 is fixedly connected to the fixing plate 722. The second rail portion 741 is fixed to the fixing plate 722, the second rail portion 741 extends in the third direction Z, and the second sliding portion 742 is slidably connected to the second rail portion 741, i.e., the second sliding portion 742 slides in the third direction Z. The spring-loaded row pin 744 is fixed to the adapter plate 743, and the adapter plate 743 is fixedly connected to the second sliding portion 742.

The spring-loaded row pin 744 is configured to fix the signal interface 91 of the biochemical sensing array 9, preventing the biochemical sensing array 9 from shifting during testing, which is conducive to improving the testing accuracy and stability. In some embodiments, the spring-loaded row pin 744 also serves as an electrical connection structure, and the spring-loaded row pin 744 contacts with the signal interface 91 to form an electrical connection to input signals from the biochemical sensing array 91 to the detection circuit board 73.

In some embodiments, the detection circuit board 73 is provided with a detection circuitry.

In some embodiments, the micro-controller includes a microcontroller, and a control program is provided in the micro-controller. The micro-controller is configured to: in response to receiving the in-position signal transmitted from the in-position sensor 75, control the second sliding portion 742 to move a preset distance in the third direction Z to drive the spring-loaded row pin 744 to close to the biochemical sensing array 9 until the spring-loaded row pin 744 contacts with the signal interface 91 of the biochemical sensing array 9, fix the biochemical sensing array 9 on the fixed surface 71, and control the detection circuit board 73 to calibrate or detect the biochemical sensing array 9.

In some embodiments, the micro-controller and the detection circuit board 73 are integrally provided on a same printed circuit board to reduce a volume of the detection module 7.

In some embodiments, a sliding distance (i.e., the preset distance) of the second sliding portion 742 is less than or equal to 5 mm.

In some embodiments, at least one first groove is provided on the fixed surface 71, an opening of each of the at least one first groove matches the bottom plate 411 of the tray 41, and the at least one first groove is configured to hold the tray 41 and the biochemical sensing array 9 held in the tray 41. In this way, the at least one first groove restricts a placement position of the tray 41 on the fixed surface 71, so that the spring-loaded row pin 744 corresponds to the signal interface 91 of the biochemical sensing array 9.

In some embodiments, the silo module 4 includes at least one second groove, an opening of each of the at least one second groove matches the bottom plate 411 of the tray 41, and the at least one second groove is configured to hold the tray 41 and the biochemical sensing array 9 held in the tray 41.

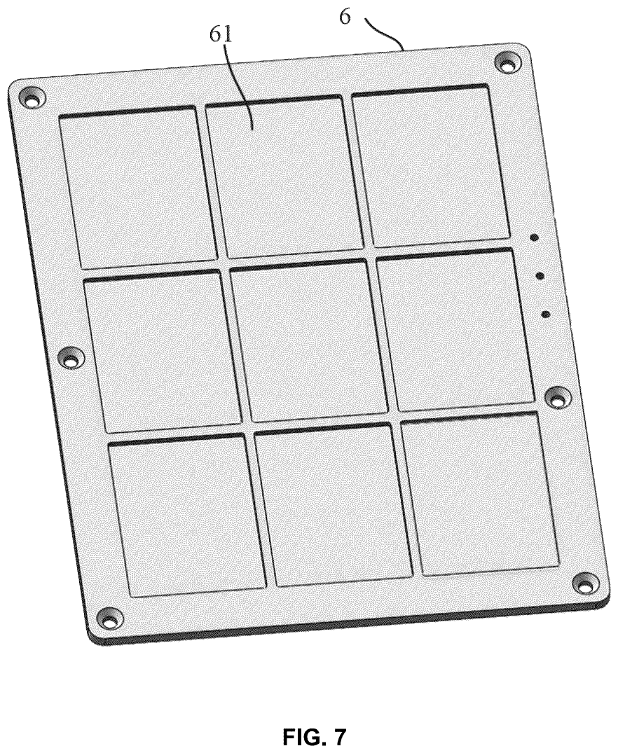

FIG. 7 is a schematic diagram illustrating a structure of a test sample loading module according to some embodiments of the present disclosure. FIG. 8 is another schematic diagram illustrating a structure of a test sample loading module according to some embodiments of the present disclosure.

In some embodiments, as shown in FIG. 7, the test sample loading module 6 includes at least one third groove 61, an opening of each of the at least one third groove 61 matches the bottom plate 411 of the tray 41, and the at least one third groove 61 is configured to hold the tray 41 and the biochemical sensing array 9 held in the tray 41. A structure of the third groove 61 holding the tray 41 is shown in FIG. 8.

The first groove, the second groove, and the third groove 61 are configured to hold the tray 41. In some embodiments, the openings of the first groove, the second groove, and the third groove 61 match the bottom plate 411 of the tray 41. The first groove, the second groove, and the third groove 61 correspond one-to-one with the tray 41.

In some embodiments, as shown in FIG. 2, the testing platform 100 further includes an array collection module and a separation structure, and the second opening 114 is provided on the surface 111, and the array collection module and the separation structure at least partially overlaps with the second opening 114 in the third direction Z.

The tray 41 may pass through the second opening 114. The array collection module and the separation structure are located on a side of the surface 111 away from the three-axis motion platform 1, i.e., the array collection module and the separation structure are located below the surface 111.

In some embodiments, as shown in FIG. 4, a third opening 416 is provided on the bottom plate 411 of the tray 41; and the third opening 416 penetrates the bottom plate 411 along a direction of the thickness of the bottom plate 411. The separation structure may pass through the third opening 416 and contact with the biochemical sensing array 9 in the tray 41 to eject the biochemical sensing array 9 from the trays 41, so as to realize the separation of the biochemical sensing array 9 from the trays 41.

After the biochemical sensing array 9 is detected, the robotic arm module 2 moves above the second opening 114 under the drive of the three-axis motion module 1, and then moves toward the base 11 in the third direction Z, so that the trays 41 continues to move downward after passing through the second opening 114 until the separation structure resists against the biochemical sensing array 9 in the tray 41 and ejects the biochemical sensing array 9 from the tray 41, so as to realize the separation of the biochemical sensing array 9 from the trays 41. A separated biochemical sensing array 9 falls into the array collection module; and a separated tray 41 is transferred to the silo module 4 by the robotic arm module 2, which is used for placing the undetected biochemical sensing array 9.

It should be noted that FIG. 2 only exemplarily illustrates that the second opening 114 is disposed between the test sample loading module 6 and the detection module 7, which does not constitute a limitation of the description. In other embodiments, the second opening 114 may also be disposed on the surface 111 within a movement range of the robotic arm module 2.

In some embodiments, the testing platform 100 further includes a host computer, the host computer is located at a user terminal, and a user may set a parameter condition by the host computer. The parameter condition at least includes a total count of biochemical sensing arrays 9 to be detected, a count of detections once, or the like.

Merely by way of example, the total count of the biochemical sensing arrays 9 to be detected is 200, the count of detections once is 6, and the previous operation is repeatedly performed for 6 times before performing the next operation. The detecting process includes: in response to detecting a start command, opening a first round of a detection program, controlling the robotic arm module 2 to repeatedly perform an operation of transferring the biochemical sensing array 9 placed in the silo module 4 to the detection module 7 for 6 times, and the biochemical sensing array 9 being calibrated by the detection module 7; then controlling the robotic arm module 2 to repeatedly perform an operation of transferring a calibrated biochemical sensing array 9 to the test sample loading module 6 for 6 times; then controlling the pipetting module 3 to repeatedly perform a sample loading operation of aspirating a liquid to be tested and dropping the liquid to be tested until all the biochemical sensing arrays 9 placed in the test sample loading module 6 are loaded; then performing a sample loading operation of transferring a sample-loaded biochemical sensing array 9 to the detection module 7 repeatedly for 6 times, and the detection module 7 detecting the sampled biochemical sensing array 9; and finally, controlling the robotic arm module 2 to repeatedly perform an operation of separating a detected biochemical sensing array 9 from the tray 41 and placing the separated tray 41 in the silo module 4, and the first round of the detection program being completed; opening the next round of the detection program, repeating the above operations until all biochemical sensing arrays 9 to be detected are detected, ending the detection program, and exiting the detection model.

In some embodiments, as shown in FIG. 2, in fully automatic assembly-line biochemical testing platform 100, the detection module 7 includes at least one in-position sensor 75, at least one fixing mechanism 74, and at least one detection circuit board 73, and the fixed surface 71 includes at least one first groove; the at least one first groove, the at least one in-position sensor 75, the at least one fixing mechanism 74, and the at least one detection circuit board 73 are in one-to-one correspondence.

Embodiments of the present disclosure also provide a control method for a fully automatic assembly-line biochemical testing platform (hereinafter referred to as the control method). The control method may be performed by a control module (e.g., the control module 10) for controlling any testing platform described above.

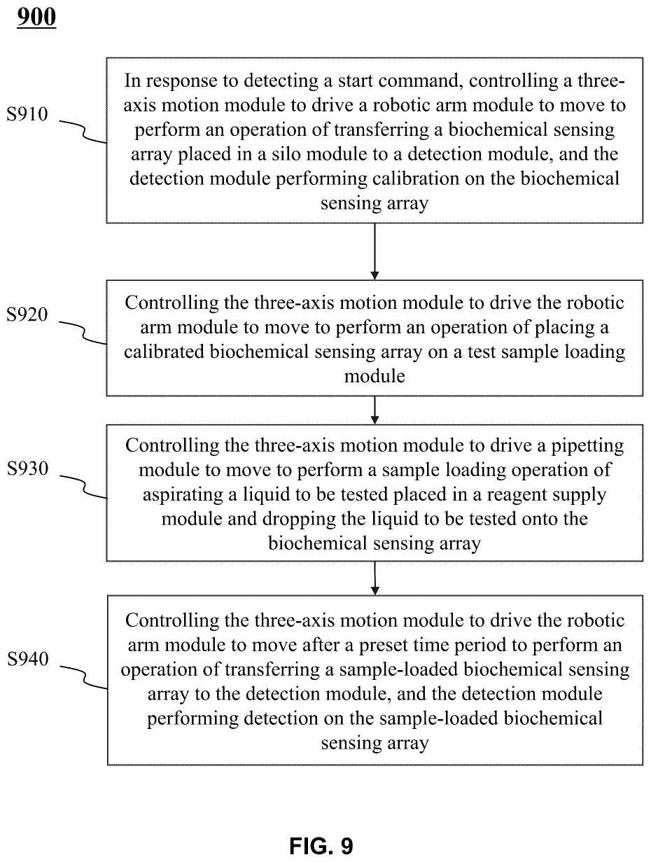

FIG. 9 a flowchart illustrating an exemplary process of a control method for a fully automatic assembly-line biochemical testing platform according to some embodiments of the present disclosure.

In some embodiments, as shown in FIG. 9, a process 900 may be performed by the control module 10 for controlling the testing platform 100. The process 900 includes the following operations.

In S910, in response to detecting a start command, the three-axis motion module 1 is controlled to drive the robotic arm module 2 to move to perform an operation of transferring the biochemical sensing array 9 placed in the silo module 4 to the detection module 7, and the detection module 7 performs calibration on the biochemical sensing array 9.

In some embodiments, in conjunction with FIGS. 1 and 2, the robotic arm module 2 moves to the silo module 4 under the drive of the three-axis motion module 1 to grip the biochemical sensing array 9 placed in the silo module 4; and then the robotic arm module 2 moves to the detection module 7 under the drive of the three-axis motion module 1 to transfer the biochemical sensing array 9 to the detection module 7, and the detection module 7 detects the biochemical sensing array 9 to calibrate the biochemical sensing array 9.

In S920, the three-axis motion module 1 is controlled to drive the robotic arm module 2 to move to perform an operation of placing the calibrated biochemical sensing array 9 on the test sample loading module 6.

In some embodiments, the robotic arm module 2 grips the calibrated biochemical sensing array 9 and moves to the test sample loading module 6 under the drive of the three-axis motion module 1 to place the calibrated biochemical sensing array 9 on the test sample loading module 6.

In S930, the three-axis motion module 1 is controlled to drive the pipetting module 3 to move to perform a sample loading operation of aspirating a liquid to be tested placed in the reagent supply module 5 and dropping the liquid to be tested onto the biochemical sensing array 9.

In some embodiments, the pipetting module 3 moves to the reagent supply module 5 under the drive of the three-axis motion module 1 to aspirate the liquid to be tested; then moves to the test sample loading module 6 under the drive of the three-axis motion module 1 to drop the liquid to be tested onto the biochemical sensing array 9.

In S940, the three-axis motion module 1 is controlled to drive the robotic arm module 2 to move after a preset time period to perform an operation of transferring a sample-loaded biochemical sensing array 9 to the detection module 7, and the detection module 7 performs detection on the sample-loaded biochemical sensing array 9.

In some embodiments, after waiting for the preset time period after sample loading, the robotic arm module 2 grips the biochemical sensing array 9 with a dropped liquid to be tested and moves to the detection module 7 under the drive of the three-axis motion module 1 to transfer the biochemical sensing array 9 with the dropped liquid to be tested to the detection module 7. The detection module 7 detects the biochemical sensing array 9 with the dropped liquid to be tested to obtains a target detection metric. More descriptions regarding the preset time period may be found in FIGS. 1 and 2 and related descriptions thereof.

In some embodiments of the present disclosure, the testing platform can realize a fully automatic operation and an assembly-line testing of the biochemical sensing array, which can eliminate the need for manual operation and reduce the error caused by manual intervention, so as to improve the testing efficiency and the testing quality and satisfy the needs of batch testing.

In some embodiments, before the pipette 31 performs the operation of aspirating the liquid to be tested, the control method further includes: controlling the three-axis motion module 1 to drive the pipette 31 to move to the pipette tip module 8 and to drive the pipette 31 to move toward the pipette tip module 8 in a third direction, and the pipette being mounted with the pipette tips 82 utilizing pressure. More descriptions regarding the part may be found in FIG. 1, FIG. 2, and FIG. 5 and related descriptions thereof.

In some embodiments, after the pipette 31 is mounted with the pipette tips 82, the control method further includes: controlling the three-axis motion module 1 to drive the pipette 31 to move to the reagent supply module 5, and controlling the first cylinder 32 to move in the third direction, the first cylinder 32 pressing the first button 312, the pipette 31 performing an operation of aspirating the liquid to be tested to the pipette tips 82; and controlling the three-axis motion module 1 to drive the pipette 31 to move to the test sample loading module 6, and controlling the first cylinder 32 to move in the third direction, the first cylinder pressing the first button 312 again, and the pipette 31 performing a sample loading operation of dropping the liquid to be tested in the pipette tips onto the biochemical sensing array 9. More descriptions regarding the part may be found in FIG. 1 and FIG. 5 and related descriptions thereof.

In some embodiments, after performing the sample loading operation, the control method further includes controlling the three-axis motion module 1 to drive the pipette 31 to move above the first opening, controlling the second cylinder to move in a third direction, the second cylinder 33 pressing the second button 313, and the pipette 31 performing an operation of unloading the pipette tips 82. For more descriptions regarding the part may be found in FIG. 1, FIG. 2, and FIG. 5 and related descriptions thereof.

Merely by way of example, taking the fully automated in-line biochemical testing platform 100 shown in FIGS. 1-8 as an example, the working process is as follows: when the program begins to perform a command of the detection process, the transfer portion 23 of the robotic arm module 2 moving above the silo module 4 under the drive of a three-axis (XYZ) motion module 1, the transfer portion 23 gripping the tray 41 for placing the biochemical sensing array 9, transferring the biochemical sensing array 9 and the tray 41 simultaneously to the detection module 7, placing the biochemical sensing array 9 in a second groove provided on the fixed surface 71, the in-position sensor 75 sending an in-position signal to a micro-controller when detecting that the tray 41 is placed in the second groove, the micro-controller controlling the second sliding portion 742 to move in the third direction Z to drive the spring-loaded row pin 744 to move downward in the third direction Z until the spring-loaded row pin 744 contacts with the signal interface 91 of the biochemical sensing array 9, and the detection module 7 beginning to enter a calibration model; the transfer portion 23 transferring the calibrated biochemical sensing array 9 to the third groove 61 of the test sample loading module 6 after the calibration is completed; the pipette 31 moving above the pipette tip module 8 under the drive of the three-axis motion module 1, the pipette 31 being controlled to move downward in the third direction Z, and the pipette tips 82 being mounted on the nozzles 314 of the pipette 31 by pressure, the pipette 31 mounted with the pipette tips 82 moving to the reagent supply module 5, the pipette 31 moving downward in the third direction Z, and the pipette tips 82 inserting into test tubes, the first cylinder 32 being controlled to move in the third direction Z at the time, and the first cylinder 32 pressing the first button 312 of the pipette 31 to aspirate the liquid to be tested in the test tubes into the pipette tips 82; the pipette 31 moving above the test sample loading module 6 after the liquid to be tested is aspirated, the first cylinder 32 being controlled to move in the third direction Z, the first cylinder 32 pressing the first button 312 of the pipette 31 again to drop the liquid to be tested into the biochemical sensing array 9, the transfer portion 23 moving to the test sample loading module 6 after a fusion of a preset time period to transfer the sample-loaded biochemical sensing array 9 to the fixed surface 71 of the detection module 7, the second sliding part driving the spring-loaded row pin 744 to move downward in the third direction Z after the in-position sensor 75 obtains the in-position signal until the spring-loaded row pin 744 contacts with the signal interface 91 of the biochemical sensing array 9, the detection module 7 entering into a detection model to perform detection on the biochemical sensing array 9, the transfer portion 23 transferring the biochemical sensing array 9 above the second opening 114 after the detection is completed and then moving toward the base 11 in the third direction Z, so that the trays 41 pass through the second opening 114 and then continue to move downward until a separation structure resists against the biochemical sensing array 9 in the trays 41 and ejects the biochemical sensing array 9 from the trays 41, so as to realize that the biochemical sensing array 9 is separated from the tray 41, a separated biochemical sensing array 9 falling into an array collection module, a separated tray 41 being transferred by the robotic arm module 2 to the silo module 4 for placing the undetected biochemical sensing array 9, and starting a new round of detection.

It should be noted that the descriptions regarding the process 900 are intended to be exemplary and illustrative only and does not limit the scope of application of the present disclosure. For a person skilled in the art, various corrections and changes may be made to the process 900 under the guidance of the present disclosure. However, the corrections and changes remain within the scope of the present disclosure.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those modifications, improvements, and amendments are suggested in the present disclosure, so those modifications, improvements, and amendments remain within the spirit and scope of the exemplary embodiments of the present disclosure.

Similarly, it should be noted that in order to simplify the presentation of the present disclosure of the present disclosure, and thereby aid in the understanding of one or more embodiments of the present disclosure, the descriptions of embodiments of the present disclosure sometimes group multiple features together in a single embodiment, accompanying drawings, or in a description thereof. However, the method of disclosure does not imply that the objects of the present disclosure require more features than those mentioned in the claims. In fact, the embodiments have fewer features than all of the individual embodiments disclosed above.

Finally, it should be understood that the embodiments described in the present disclosure are only configured to illustrate the principles of the embodiments of the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

1. A fully automatic assembly-line biochemical testing platform, comprising a three-axis motion module, a robotic arm module, a pipetting module, a silo module, a reagent supply module, a test sample loading module, a detection module, and a control module; wherein the three-axis motion module, the robotic arm module, the pipetting module, and the detection module are electrically connected to the control module; and the robotic arm module and the pipetting module are fixed to the three-axis motion module; wherein
the control module is configured to:
in response to detecting a start command, control the three-axis motion module to drive the robotic arm module to move to perform an operation of transferring a biochemical sensing array placed in the silo module to the detection module, wherein the detection module performs calibration on the biochemical sensing array;
control the three-axis motion module to drive the robotic arm module to move to perform an operation of placing a calibrated biochemical sensing array on the test sample loading module;
control the three-axis motion module to drive the pipetting module to move to perform a sample loading operation of aspirating a liquid to be tested placed in the reagent supply module and dropping the liquid to be tested onto the calibrated biochemical sensing array; and
control the three-axis motion module to drive the robotic arm module to move after a preset time period to perform an operation of transferring a sample-loaded biochemical sensing array to the detection module, wherein the detection module performs detection on the sample-loaded biochemical sensing array;
the detection module includes a fixed surface, an in-position sensor, a fixing mechanism, a fixing frame, a detection circuit board, and a micro-controller, and the fixing mechanism includes a spring-loaded row pin, an adapter plate, a second rail portion, and a second sliding portion; wherein
the fixing frame is configured to fix the second rail portion, the second sliding portion slides along the second rail portion, the second sliding portion is fixedly connected to the adapter plate, the adapter plate is fixedly connected to the spring-loaded row pin; the spring-loaded row pin is further electrically connected to the adapter plate, the adapter plate is electrically connected to the detection circuit board by a flexible wiring, the in-position sensor, the second sliding portion, and the detection circuit board are electrically connected to the micro-controller, and the micro-controller is electrically connected to the control module; and
the micro-controller is configured to: in response to receiving an in-position signal transmitted from the in-position sensor, control the second sliding portion to slide along the second rail portion, to drive the spring-loaded row pin to contact with a signal interface of the biochemical sensing array, so as to fix the biochemical sensing array on the fixed surface, and control the detection circuit board to calibrate or detect the biochemical sensing array;
wherein the in-position signal is generated based on a detection result of the in-position sensor that the biochemical sensing array is placed on the fixed surface.

2. The fully automatic assembly-line biochemical testing platform according to claim 1, wherein the three-axis motion module includes a base, a support structure, a first motion mechanism, a second motion mechanism, a third motion mechanism, and a connecting assembly; wherein
the support structure is located on the base;
the first motion mechanism is located on a side of the support structure away from the base, the first motion mechanism extending in a first direction;
the second motion mechanism is slidably connected to the first motion mechanism by the connecting assembly, the second motion mechanism moving in the first direction and extending in a second direction;
the third motion mechanism is slidably connected to the second motion mechanism by the connecting assembly, the third motion mechanism moving in the second direction and extending in a third direction; and
the robotic arm module and the pipetting module are slidably connected to the third motion mechanism by the connecting assembly, the robotic arm module and the pipetting module moving in the third direction;
wherein the first direction, the second direction, and the third direction are perpendicular to each other.

3. The fully automatic assembly-line biochemical testing platform according to claim 2, wherein the first motion mechanism includes a first synchronous belt and a first motor, and the first motor drives the first synchronous belt to move in the first direction;
the second motion mechanism includes a second synchronous belt and a second motor, and the second motor drives the second synchronous belt to move in the second direction; and
the third motion mechanism includes a third synchronous belt and a third motor, and the third motor drives the third synchronous belt to move in the third direction.

4. The fully automatic assembly-line biochemical testing platform according to claim 3, wherein the first synchronous belt includes a first sub-synchronous belt and a second sub-synchronous belt, and the first sub-synchronous belt and the second sub-synchronous belt are set in parallel; and
the first motion mechanism further includes couplings and a connecting rod, the connecting rod connects the first sub-synchronous belt to the second sub-synchronous belt by the couplings, and the couplings further connect to the first motor.

5. The fully automatic assembly-line biochemical testing platform according to claim 2, wherein the robotic arm module includes a first rail portion, a first sliding portion, and a transfer portion, wherein the first rail portion is slidably connected to the third motion mechanism by the connecting assembly, the first rail portion extends in the third direction, the first sliding portion moves in the third direction, the first sliding portion is fixedly connected to the transfer portion, and the transfer portion is configured to transfer the biochemical sensing array.

6. The fully automatic assembly-line biochemical testing platform according to claim 5, wherein the transfer portion includes a fork structure; and
the silo module includes stacked trays, the trays being configured to hold the biochemical sensing array, wherein the trays include insertion holes, the insertion holes being matched to the fork structure.

7. The fully automatic assembly-line biochemical testing platform according to claim 1, wherein the pipetting module includes a pipette, and the fully automatic assembly-line biochemical testing platform further includes a pipette tip module, the pipette tip module including a tip box and pipette tips, the tip box being configured to accommodate a plurality of the pipette tips arranged in an array; and
the control module is further configured to: before the pipette performs an operation of aspirating the liquid to be tested, control the three-axis motion module to drive the pipette to move to the pipette tip module, to drive the pipette to move toward the pipette tips in a third direction, the pipette being mounted with the pipette tips utilizing pressure.

8. The fully automatic assembly-line biochemical testing platform according to claim 7, wherein the pipetting module further includes a first cylinder, and the pipette includes a pipette body and a first button; wherein
the control module is further configured to:
after the pipette is mounted with the pipette tips, control the three-axis motion module to drive the pipette to move to the reagent supply module, and control the first cylinder to move in the third direction, the first cylinder pressing the first button, and the pipette performing an operation of aspirating the liquid to be tested to the pipette tips; and
control the three-axis motion module to drive the pipette to move to the test sample loading module, and control the first cylinder to move in the third direction, the first cylinder pressing the first button again, and the pipette performing a sample loading operation of dropping the liquid to be tested in the pipette tips onto the biochemical sensing array.

9. The fully automatic assembly-line biochemical testing platform according to claim 7, wherein the pipetting module further includes a second cylinder, the pipette further includes a second button, and the base of the three-axis motion module is provided with a first opening; wherein
the fully automatic assembly-line biochemical testing platform further includes a pipette tip collection module; and the pipette tip collection module at least partially overlaps with the first opening in the third direction; and
the control module is further configured to control the three-axis motion module to drive the pipette to move above the first opening, and control the second cylinder to move in the third direction, the second cylinder pressing the second button, the pipette performing an operation of unloading the pipette tips.

10. The fully automatic assembly-line biochemical testing platform according to claim 7, wherein the pipette further includes a plurality of nozzles arranged in an array, and the plurality of nozzles are connected to the pipette tips in one-to-one correspondence; and
the control module is further configured to regulate a spacing between adjacent nozzles and regulate a volume of the liquid to be tested aspirated by the pipette tips in a single operation.

11. (canceled)

12. A control method for a fully automatic assembly-line biochemical testing platform, implemented by the fully automatic assembly-line biochemical testing platform o f claim 1, wherein the fully automatic assembly-line biochemical testing platform comprises a three-axis motion module, a robotic arm module, a pipetting module, a silo module, a reagent supply module, a test sample loading module, a detection module, and a control module; wherein the three-axis motion module, the robotic arm module, the pipetting module, and the detection module are electrically connected to the control module; and the robotic arm module and the pipetting module are fixed to the three-axis motion module;
the control method comprising:
in response to detecting a start command, controlling the three-axis motion module to drive the robotic arm module to move to perform an operation of transferring a biochemical sensing array placed in the silo module to the detection module, and the detection module performing a calibration on the biochemical sensing array;
controlling the three-axis motion module to drive the robotic arm module to move to perform an operation of placing a calibrated biochemical sensing array on the test sample loading module;
controlling the three-axis motion module to drive the pipetting module to move to perform a sample loading operation of aspirating a liquid to be tested placed in the reagent supply module and dropping the liquid to be tested onto the calibrated biochemical sensing array; and
controlling the three-axis motion module to drive the robotic arm module to move after a preset time period to perform an operation of transferring a sample-loaded biochemical sensing array to the detection module, and the detection module performing detection on the sample-loaded biochemical sensing array.

13. The control method according to claim 12, wherein the pipetting module includes a pipette, and the fully automatic assembly-line biochemical testing platform further includes a pipette tip module, the pipette tip module including a tip box and pipette tips, the tip box being configured to accommodate a plurality of the pipette tips arranged in an array; and
before the pipette performs an operation of aspirating the liquid to be tested, the control method further comprises:
controlling the three-axis motion module to drive the pipette to move to the pipette tip module, to drive the pipette to move toward the pipette tips in a third direction, and the pipette being mounted with the pipette tips utilizing pressure.

14. The control method according to claim 13, wherein the pipetting module further includes a first cylinder, and the pipette includes a pipette body and a first button; and
after the pipette is mounted with the pipette tips, the control method further comprises:
controlling the three-axis motion module to drive the pipette to move to the reagent supply module, and controlling the first cylinder to move in the third direction, the first cylinder pressing the first button, and the pipette performing an operation of aspirating the liquid to be tested to the pipette tips; and
controlling the three-axis motion module to drive the pipette to move to the test sample loading module, and controlling the first cylinder to move in the third direction, the first cylinder pressing the first button again, and the pipette performing a sample loading operation of dropping the liquid to be tested in the pipette tips onto the biochemical sensing array.

15. The control method according to claim 13, wherein the pipetting module further includes a second cylinder, the pipette further includes a second button, and the base of the three-axis motion module is provided with a first opening; wherein
the fully automatic assembly-line biochemical testing platform further includes a pipette tip collection module; and the pipette tip collection module at least partially overlaps with the first opening in the third direction; and
the control method further comprises:
controlling the three-axis motion module to drive the pipette to move above the first opening, controlling the second cylinder to move in the third direction, the second cylinder pressing the second button, and the pipette performing an operation of unloading the pipette tips.
